(19) United States
(12) Patent Application Publication
(10) Pub. No.: US 2025/0257255 A1
(43) Pub. Date: Aug. 14, 2025

(54) DUAL FUNCTION ADDITIVE FOR WATER BASED DRILLING FLUIDS

(71) Applicant: LAMBERTI SPA, Albizzate (IT)

(72) Inventors: Laura VIGANÒ, Parabiago (IT); Luigi MERLI, Saronno (IT); Letizia PRIVITERA, Sumirago (IT)

(73) Assignee: LAMBERTI SPA, Albizzate (IT)

(21) Appl. No.: 18/851,292

(22) PCT Filed: Apr. 6, 2023
(86) PCT No.: PCT/EP2023/059112

§ 371 Date: Sep. 26, 2024

(30) Foreign Application Priority Data
Apr. 12, 2022 (IT) 102022000007208

(51) Int. Cl. C09K 8/22; E21B 21/06

(52) U.S. Cl. CPC C09K 8/22; E21B 21/062

(57) ABSTRACT

Method of improving the rate of penetration of the drilling bit when drilling a wellbore through unstable clayey soils and of reducing the soil disaggregation, the method comprising drilling the well in the presence of a water based drilling fluid that contains a dual function additive that improves the lubrication between the bit and the well walls while inserting the drilling fluid against such soils.

.

### FIELD OF THE INVENTION

The present invention relates to a method of improving the rate of penetration of the drilling bit when drilling a wellbore through unstable clayey soils and of reducing the soil disaggregation. The method comprises drilling the well in the presence of a water based drilling fluid that contains a dual function additive that improves the lubrication between the bit and the well walls while inserting the drilling fluid against interaction with such soils.

### BACKGROUND OF THE ART

Drilling fluids, which are also called drilling muds, are complex mixtures of chemicals used in drilling operations for the production of hydrocarbons and natural gas from subterranean reservoirs. Typically, oil and gas wells are drilled using drilling equipment in the presence of a drilling fluid.

Drilling fluids can be classified according to the nature of their continuous phase. There are oil based drilling fluids, in which the solids are suspended in a continuous oleaginous phase and optionally water or brine are emulsified into the oleaginous phase.

Alternatively, water based drilling fluids contain solids suspended in water or brine.

Drilling fluids are pumped inside the drilling shaft and exit from the drilling bit through small openings.

The drilling fluid returns to the surface through the annulus between the outside of the drilling shaft and the borehole wall.

Drilling muds, through the several additives they contain, perform a number of functions.

Exemplary of these functions are: cooling the drilling bit, creating hydrostatic pressure to avoid uncontrolled blow outs and to help supporting the weight of the borehole walls, carrying drill cuttings up to the surface and suspending them when the fluid circulation is stopped, creating a filter cake having low permeability on the borehole walls and, in case, on the surface of the porous geological formations, reducing the amount of swelled formation solids that can potentially weaken the walls of the wellbore.

Moreover, drilling fluids perform a lubricating action.

Poor lubrication is of common concern in drilling, possibly impairing the operations and, in the worst case, resulting in drill string and drill pipe sticking. Defects of lubrication may arise from wearing of the metal parts sliding over each other, from accretion of debris on the drilling bit and from the rubbing of the drilling bit on the borehole walls. This last defect is particularly of concern in the presence of unstable clayey soils, where the drilling bit may have an increased tendency to adhere on the well walls.

This phenomenon is usually controlled by dosing specific lubricants in the drilling fluid. Several treatments have been attempted to solve these problems, including addition of surfactants, inorganic salts or lubricants to the drilling mud, but none of these additives has proved to fully satisfy the expectations.

It has now been found that a mixture of 1,6-diaminohexane (CAS No. 124-09-4, in the present text “hexylenediamine”) and 7-azatridecane-1,13-diamine (CAS No. 143-23-7, in the present text “dihexylenetriamine”), besides acting as efficient drilling fluid inhibitor against interaction with unstable and clayey soils, also significantly favors the lubrication (by lowering the adhesion) between the drilling bit and the borehole walls, thus also performing as a rate of penetration enhancer (ROPE).

In fact, in terms of functionality, ROPEs generally penetrate the filter cake after it has been formed. As a result, ROPEs control bit-balling by almost primarily reducing the interaction (adhesion) between the metal and the formation debris (what is sometime called “metal-rock interaction”).

The fact that ROPEs improve the lubrication between the drilling bit and the borehole walls, however, does not mean that ROPEs strictly behave as lubricants in the drilling process.

Drilling lubricants are not necessarily ROPEs, and vice-versa.

Lubricants are properly intended to form a film on the metallic surfaces, which substantially reduces torque during pipe rotation and drag during trips.

In other words, ROPEs and lubricants are discerned based on how they interact with the filter cake and metal surfaces.

ROPEs enter the filter cake and reduce its tendency of adhere to the metal parts of the drilling bit and apparatus, lubricants prevalently act at the metal-metal interphase by reducing the coefficient of friction between the sliding metal surfaces.

The action of hexylenediamine and dihexylenetriamineas clay swelling inhibitor is known, but, as far as the applicant knows, the excellent enhancement of the rate of penetration of the bit induced by a mixture of hexylenediamine and dihexylenetriamine, was not known in the art.

In the present text, by unstable clayey soil we mean not only swellable but also dispersive clay soils that are susceptible to erosion. Typically, such soils contain high percentages of exchangeable sodium cations.

Dispersive clay soils are characterized by their tendency to disaggregate in presence of water and by detachments that lead to problems of stability. Various methods are known to identify dispersive soils, some of which are standardized methods. Here we mention the double hydrometer test (Test method ASTM D4221-18), the pinhole dispersion test (Test method ASTM D4647/D4647M), the crumb test (Test method ASTM D6572) and the pore water extraction test (Test method ASTM D4542).

According to the present disclosure, the test methods may be performed individually or used together to verify the dispersivity of the clayey soil.

The method and the dual function additive of this disclosure are particularly suitable for drilling a wellbore in dispersive clayey soils.

### SUMMARY OF THE INVENTION

The present disclosure relates to a method for drilling boreholes that takes advantage from this dual function of hexylenediamine and dihexylenetriamine mixtures.

More in detail, the disclosure relates to a method of improving the rate of penetration of the drilling bit and of reducing the soil disaggregation when drilling a wellbore in unstable clayey soils. The method comprises the following steps: (a) adding to a water based drilling fluid from 0.02% to 5% by weight of a dual function additive, wherein the dual function additive is a mixture of hexylenediamine and dihexylenetriamine in a weight ratio from 0.01 to 4; (b) drilling the borehole in the presence of the water based drilling fluid that contains the dual function additive, thereby improving the rate of penetration of the drilling bit and reducing the soil disaggregation.

The present disclosure further relates to the use of from 0.02% to 5% by weight of the dual function additive, in a water based drilling fluid, for improving the rate of penetration of the drilling bit while reducing the soil disaggregation when drilling a wellbore in unstable clayey soils.

The above defined dual function additive in contact with the unstable clayey soils both improves the drilling bit lubrication while inserting the drilling fluid against the clays.

### DETAILED DESCRIPTION OF THE INVENTION

According to a preferred aspect, in the water based drilling fluid of the method and use, from 0.04 to 3 wt % of the dual function additive are added.

In the dual function additive, the weight ratio between hexylenediamine and dihexylenetriamine is preferably from 0.01 to 4, more preferably from 0.2 to 1. The dual function additive is conveniently added to the water based drilling fluid formulated in a liquid medium such as water, glycol, glycerol, polyglycerol, glycol ester, glycol ether, or mixtures thereof (formulated dual function additive).

The formulated dual function additive is preferably a solution of the dual function additive in the liquid medium, more preferably an aqueous solution (aqueous dual function additive solution, hereafter AAS).

In the method and use, the AAS consents to prepare mixtures of hexylenediamine and dihexylenetriamine that are pourable and are stable and ready for use on the well site.

In an advantageous embodiment, the pH of the aqueous AAS is adjusted between about 9 and about 11 by addition of organic or inorganic acids, the preferred being hydrochloric acid, phosphoric acid, formic acid, acetic acid, more preferably hydrochloric acid or acetic acid, most preferably hydrochloric acid.

Advantageously, in the method and use according to this disclosure, the pH of the water based drilling fluid is from about 8 to about 12.

The dual function additive may be prepared by mixing dihexylenetriamine (melting point 33-36° C., boiling point 332.8° C., 165° C. at 4 mmHg) and hexylenediamine (melting point 42-45° C., boiling point 205° C.) as such, or directly in diluted form by mixing the commercially available mixtures of hexylenediamine and dihexylenetriamine.

Otherwise, aqueous solutions that contain both hexylenediamine and dihexylenetriamine are commercially available.

Mixtures of hexylenediamine and dihexylenetriamine are industrial products identified by the EC List No. 270-153-8, chemical name “Hexanedinitrile, hydrogenated, high-boiling fraction” and CAS No. 68411-90-5, or by EC List No. 907-605-7, chemical name “Reaction mass of 7-azatridecane-1,13-diamine and hexamethylenediamine” and CAS No. 68815-47-4, possibly in combination with EC List No. 211-776-7 (corresponding to Cyclohex-1,2-ylenediamine, minor component) and EC LIST No. 204-679-6 (corresponding to Hexamethylenediamine).

Such industrial products may contain high boiling point nitrogen compounds, here named “amines”, having boiling point higher than 330° C.

In a preferred embodiment, the AAS is an amines rich AAS, i.e. it contains from 1 to 50 wt %, more preferably from 10 to 25 wt %, of amines having boiling point higher than 330° C. on the total amount of hexylenediamine and dihexylenetriamine.

In this embodiment, the method of improving the rate of penetration of the drilling bit and reducing the soil disaggregation comprises the following steps: (a) adding to a water based drilling fluid from 0.02% to 5% by weight of a dual function additive that in contact with unstable clayey soils improves the drilling bit lubrication while inserting the drilling fluid against clays, wherein the dual function additive is a mixture of hexylenediamine and dihexylenetriamine in a weight ratio from 0.01 to 4, preferably from 0.2 to 2, more preferably from 0.2 to 1, which is added to the water based drilling fluid as an aqueous dual function additive solution that comprises from 1 to 50 wt %, preferably from 10 to 25 wt %, of amines having boiling point higher than 330° C. on the total amount of hexylenediamine and dihexylenetriamine; (b) drilling the borehole in the presence of the water based drilling fluid that contains the dual function additive.

The polyamine rich AAS proved to be especially suitable for improving the rate of penetration and inserting the wall of a well having unstable clayey soils in at least some areas.

Without being bound to any theory, it is believed that the amines having boiling point above 330° C., that are complex mixtures of high molecular weight nitrogen compounds, by adhering on the soil, help the hardening and levelling the walls of the well.

It has also been found that the presence of a lubricant in the drilling fluid beneficially influences the dual function additive inserting effect on the clayey soils, and, additionally, the dual function additive improves the lubricating performance of the lubricant, by increasing the rate of penetration of the bit.

Accordingly, in the method and use of the disclosure, the drilling fluid may also advantageously contain a lubricant.

Examples of suitable lubricants may include, but are not limited to vegetable oils, olefins, phosphates, esters, glycols, fatty esters, alkanol amines fatty esters, or any combination thereof.

The preferred lubricant is a vegetable oil-based lubricant.

The water based drilling fluids of the present invention may be formulated with brines.

Useful salts for the preparation of brines include, but are not limited to, sodium, calcium, aluminum, magnesium, strontium, potassium and lithium salts of chlorides, carbonates, bromides, iodides, chlorates, bromates, nitrates, formates, phosphates, sulfates.

The brine may also comprise seawater.

The density of the water based drilling fluid is generally regulated by increasing the salt concentration of the brine and/or by the addition of specific weighting agents.

Suitable weighting agents are barite, siderite, galena, dolomite, ilmenite, hematite, iron oxides, calcium carbonates and the like.

Advantageously the water based drilling fluid contains fluid loss reducers such as cellulose derivatives (preferably polyanionic cellulose) and/or starch and/or starch derivatives.

The water based drilling fluids usually also contain rheology modifiers.

Suitable rheology modifiers are gelling agents and viscosifiers, such as natural polymers or derivatives thereof, biopolymers, high molecular weight synthetic polymers, and the like.

Other conventional additives that may be contained in the water based drilling fluid are encapsulating agents, thinning agents and dispersants (such as lignosulfonates, tannins, polyacrylates and the like).

Examples are reported here below to illustrate the invention.

### EXAMPLES

Simplified water based muds (without weighting agents) were prepared according to the formulas reported in Table 1 and in Table 2.

Table 1 and Table 2 also report the rheology of the mud as such (before hot rolling).

TABLE 1
Muds composition

| | 1 (Blank A) | 2 | 3 | 4 | 5 |
|---|---|---|---|---|---|
| Fresh Water | 1000 | 1000 | 1000 | 1000 | 1000 |
| NaCl | 250 | 250 | 250 | 250 | 250 |
| Na₂CO₃ | 0.71 | 0.71 | 0.71 | 0.71 | 0.71 |
| API Xanthan Gum | 2.9 | 2.9 | 2.9 | 2.9 | 2.9 |
| API starch | 5.7 | 5.7 | 5.7 | 5.7 | 5.7 |
| LAMPAC EXLO | 4.3 | 4.3 | 4.3 | 4.3 | 4.3 |
| AAS1 | | 20 | | | |
| AAS2 | | | 20 | | 20 |
| AAS3 | | | | 20 | |
| LUBRICANT | | | | | 20 |
| NaOH (20% solution) | if | if | if | if | if |
| | necessary | necessary | necessary | necessary | necessary |
| | to pH > 9 | to pH > 9 | to pH > 9 | to pH > 9 | to pH > 9 |
| Dispersive Clay (sized | 85.7 | 85.7 | 85.7 | 85.7 | 85.7 |
| between 2 and 4 mm)* | | | | | |

*Dispersive clay composition

| | | | Illite- |
|---|---|---|---|
| Chlorite | Kaolinite | Illite | smectite |
| 1 | 35 | 36 | 28 |

RHEOLOGY BHR of the muds

| | 1 (Blank A) | 2 | 3 | 4 | 5 |
|---|---|---|---|---|---|
| Temperature | 25 | 25 | 25 | 25 | 25 |
| pH | 9.0 | 9.0 | 10.4 | 9.9 | 10.4 |
| 600 rpm | 32 | 32 | 31 | 31 | 32 |
| 300 rpm | 22 | 22 | 21 | 21 | 22 |
| 200 rpm | 18 | 18 | 17 | 17 | 18 |
| 100 rpm | 13 | 13 | 13 | 12 | 13 |
| 6 rpm | 5 | 5 | 5 | 5 | 5 |
| 3 rpm | 4 | 4 | 4 | 4 | 4 |
| Apparent Viscosity | 16 | 16 | 15.5 | 15.5 | 16 |
| Plastic viscosity | 10 | 10 | 10 | 10 | 10 |
| Yield Point | 12 | 12 | 11 | 11 | 12 |

*relative percentage of clay minerals in the <2 μm clay size fraction
BHR = before hot rolling

TABLE 2
Muds Compositions

| | 6 (Blank B) | 7 | 8 | 9 |
|---|---|---|---|---|
| Fresh Water | 1000 | 1000 | 1000 | 1000 |
| NaCl | 250 | 250 | 250 | 250 |
| Na₂CO₃ | 0.71 | 0.71 | 0.71 | 0.71 |
| API Xanthan Gum | 2.9 | 2.9 | 2.9 | 2.9 |
| API starch | 5.7 | 5.7 | 5.7 | 5.7 |
| LAMPAC EXLO | 4.3 | 4.3 | 4.3 | 4.3 |
| AAS2 | | 20 | | |
| EXC1 | | | 20 | 20 |
| EXC2 | | | | 20 |
| LUBRICANT | 20 | 20 | 20 | 20 |
| NaOH (20% solution) | if | if | if | if |
| | necessary | necessary | necessary | necessary |
| | to pH > 9 | to pH > 9 | to pH > 9 | to pH > 9 |
| Dispersive Clay (sized | 85.7 | 85.7 | 85.7 | 85.7 |
| between 2 and 4 mm)* | | | | |

*Dispersive clay composition

| | | | Illite- |
|---|---|---|---|
| Chlorite | Kaolinite | Illite | smectite |
| 1 | 35 | 36 | 28 |

RHEOLOGY BHR of the muds

| | 6 (Blank B) | 7 | 8 | 9 |
|---|---|---|---|---|
| Temperature | 25 | 25 | 25 | 25 |
| pH | 9.1 | 10.4 | 10.8 | 10.8 |
| 600 rpm | 34 | 32 | 33 | 34 |
| 300 rpm | 23 | 22 | 23 | 23 |
| 200 rpm | 19 | 18 | 19 | 19 |
| 100 rpm | 14 | 13 | 14 | 14 |
| 6 rpm | 5 | 5 | 5 | 5 |
| 3 rpm | 4 | 4 | 4 | 4 |
| Apparent Viscosity | 17 | 16 | 16.5 | 17 |
| Plastic viscosity | 11 | 10 | 10 | 11 |
| Yield Point | 12 | 12 | 13 | 12 |

*relative percentage of clay minerals in the <2 μm clay size fraction
BHR = before hot rolling

In Table 1:
LUBRICANT is a vegetable oil-based lubricant
LAMPAC EXLO is an extra low viscosity PolyAnionicCellulose (from Lamberti SpA)
AAS1 is an aqueous dual function additive solution containing about 22.7 wt % of hexylenediamine and dihexylenetriamine in a weight ratio 1.25, neutralized with hydrochloric acid, and about 21.59% of higher amines
on the total amount of hexylenediamine and dihexylenetriamine. The pH of AAS1 is 9.5 (at 5 wt % in water).
AAS2 is an aqueous dual function additive solution containing about 30 wt % of hexylenediamine and dihexylenetriamine in a weight ratio 1.26, neutralized with hydrochloric acid, and about 22.33% of higher amines on the total amount of hexylenediamine and dihexylenetriamine. The pH of AAS2 is 10.5 (5 wt % in water)
AAS3 is an aqueous dual function additive solution containing about 31.6 wt % of hexylenediamine and dihexylenetriamine in a weight ratio 0.44, neutralized with hydrochloric acid, and about 21.22% of higher amines on the total amount of hexylenediamine and dihexylenetriamine. The PH of AAS3 is 9.8 (5 wt % in water)

In Table 2:
LAMPAC EXLO, LUBRICANT and AAS2 are described above
EXC1 is a clay inhibitor of the state of the art, an aqueous solution containing about 50 wt % of polyethylenimine with an average molecular weight of 250-300 Da. The pH of EXC1 is 10.9 (5 wt % in water).
EXC2 is a ROPE of the state of the art, polypropylene glycol with molecular weight 2000 Da.

### Tests Method

The testing procedure has been designed to measure the inertization index of the drilling fluid (hardness of the treated clay, an index of its resistance to disaggregation) and the steel-rock lubrication index of clays exposed to a fluid containing various additives: the later provides a measure of the metal-rock interaction (metal-rock adhesion) and for this reason it is suitable to test the efficiency of ROP enhancers.

The method prescribes the use of a very sensitive dynamometer (rheometer Discovery HR2-TA Instruments).

Muds were hot rolled (HR) at 80° C. for 16 hours. After HR the cuttings are recovered on a 0.5 mm screen removing as much fluid as possible.

6.5 g of recovered wet cuttings are placed on the plate of the rheometer and the test is started.

### First Step: Compression

In the first step the cuttings are compressed between two steel plates (crosshatched 40 mm diameter parallel plates). The starting gap between the two plates is 8000 micron (8 mm). The compression speed is 30 micron/sec. The step ends when the axial force reaches a value of 10 N (corresponding to 1 Kg). The better the fluid inertization, the higher the hardness of the cuttings and their resistance to compression. Consequently, the higher the final distance between the plates, the higher the inertization of the drilling fluid.

### Intermediate Step

Holding time (static): 60 seconds at 10 N

### Second Step: Pulling

In the second step, the plates are returned to the starting gap at the same speed of 30 micron/sec. The better the steel-rock lubrication, the easier is to detach the upper plate form the clays cuttings and hence the lower the force that is needed for detachment. In other words, during the step of pulling, the minimum absolute value of the force (N) is an index of good lubrication index. Consequently, the lower the absolute value, the better the steel-rock lubrication

The results are reported in Table 3 and in Table 4.

The results of the tests in Table 3 show that the dual function additives, significantly harden the clays (high inertization index) while lowering the adhesion between the metal and the damp clay (high lubrication index), especially in the presence of a lubricant.

TABLE 3

| | 1 (Blank A) | 2 | 3 | 4 | 5 |
|---|---|---|---|---|---|
| Distance after compression | 831 | 3410 | 3850 | 4164 | 4416 |
| (inertizing index) | | | | | |
| % increase of distance after | — | 310 | 363 | 401 | 431 |
| compression | | | | | |
| (inertizing index) | | | | | |
| Force applied during pulling | −3.3 | −0.78 | −0.56 | −0.60 | −0.47 |
| (lubrication index) | | | | | |
| % reduction force applied | — | 76 | 83 | 81 | 86 |
| during pulling | | | | | |
| (lubrication index) | | | | | |

TABLE 4

| | 6 (Blank B) | 7 | 8* | 9* |
|---|---|---|---|---|
| Distance after compression | 956 | 4398 | 4239 | 3913 |
| (inertizing index) | | | | |
| % increase of distance after | — | 360 | 343 | 309 |
| compression (inertizing | | | | |
| index) | | | | |
| Force applied during pulling | −4.19 | −0.49 | −0.99 | −0.81 |
| (lubrication index) | | | | |
| % reduction force applied | — | 88 | 76 | 81 |
| during pulling (lubrication | | | | |
| index) | | | | |

*comparative

The results of the tests in Table 4 show that the dual function additive of the invention (AAS2) shows a better lubrication index if compared to a well know amine-based shale inhibitor with a similar inertization index and even to the combination of amine based shale inhibitor and ROPE of the state of the art.

1. A method of improving the rate of penetration of the drilling bit and reducing the soil disaggregation when drilling a wellbore in unstable clayey soils, the method comprising the following steps:
(a) adding to a water based drilling fluid from 0.02% to 5% by weight (wt %) of a dual function additive that in contact with the unstable clayey soils improves the drilling bit lubrication while inserting the drilling fluid against clays,
wherein the dual function additive is a mixture of hexylenediamine and dihexylenetriamine in a weight ratio between 0.01 and 4;
(b) drilling the borehole in the presence of the water based drilling fluid that contains the dual function additive.

2. The method of improving the rate of penetration and reducing the soil disaggregation according to claim 1, wherein the dual function additive is added to the water based drilling fluid in an aqueous solution.

3. The method of improving the rate of penetration and reducing the soil disaggregation according to claim 2 wherein the aqueous dual function additive solution comprises from 1 to 50 wt %, of amines having boiling point higher than 330° C. on the total amount of hexylenediamine and dihexylenetriamine.

4. The method of improving the rate of penetration and reducing the soil disaggregation according to claim 2 in which the aqueous dual function additive solution has pH from 9 to 11.

5. The method of improving the rate of penetration and reducing the soil disaggregation according to claim 4 wherein the pH of the aqueous dual function additive solution is adjusted by addition of hydrochloric acid, phosphoric acid, formic acid or acetic acid.

6. The method of improving the rate of penetration and reducing the soil disaggregation according to claim 1 wherein the water based drilling fluid has pH from 8 to 12.

7. Use of a dual function additive in a water based drilling fluids in an amount from 0.02% to 5% by weight % (wt %), for improving the rate of penetration of the drilling bit and reducing the soil disaggregation when drilling a wellbore in unstable clayey soils, wherein the dual function additive is a mixture of hexylenediamine and dihexylenetriamine in a weight ratio between 0.01 and 4, that in contact with the unstable clayey soils improves the drilling bit lubrication while inserting the drilling fluid against clays.

8. The use of the dual function additive according to claim 7, wherein the dual function additive contains from 1 to 50 wt %, of amines having boiling point higher than 330° C. on the total amount of hexylenediamine and dihexylenetriamine.

9. The use of the dual function additive according to claim 7 wherein the dual function additive is added to the water based drilling fluid in an aqueous solution having at pH between 9 and 11.

10. The use of the dual function additive according to claim 9, wherein the pH of the aqueous dual function additive solution is adjusted with hydrochloric acid, phosphoric acid, formic acid or acetic acid.

11. The use of the dual function additive according to claim 7, wherein the water based drilling fluid has pH between 8 and 12.
